(19) United States
(12) Patent Application Publication
(10) Pub. No.: US 2008/0192293 A1
(43) Pub. Date: Aug. 14, 2008

(54) Information processing apparatus executing process in behalf of other apparatuses or requesting other apparatuses to execute process, and proxy process execution method and proxy process execution program executed in these apparatuses

(75) Inventor: Tetsuya Sugimoto, Muko-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Chiyoda-ku (JP)

(21) Appl. No.: 12/068,672

(22) Filed: Feb. 8, 2008

(30) Foreign Application Priority Data
Feb. 9, 2007 (JP) 2007-30816

(51) Int. Cl. H04N 1/32

(52) U.S. Cl. 358/1.15

(57) ABSTRACT

In order to match a setting of a function requested for execution with the ability of the apparatus itself, a proxy MFP includes a window request reception portion to receive from a requestor MFP a transmission request for a setting window for setting a parameter necessary to execute a prescribed function, an ability information obtaining portion, a setting parameter obtaining portion and a restriction obtaining portion to receive prescribed information related to the requestor MFP, a determination portion to determine a range of parameter that can be set to execute a prescribed function, based on prescribed information received from the requestor MFP, a setting window transmission portion to transmit the determined range to the requester MFP, and an execution portion to execute a prescribed function according to a parameter received from the requestor MFP.

This application is based on Japanese Patent Application No. 2007-030816 filed with Japan Patent Office on Feb. 9, 2007, the entire content of which is hereby incorporated by reference.

### BACKGROUND OF THE INVENTION

1. Field of the Invention

The present invention relates to an information processing apparatus, a proxy process execution method, and a proxy process execution program, and more particularly to an information processing apparatus executing a process in behalf of other apparatuses or requesting other apparatuses to execute a process as well as a proxy process execution method and a proxy process execution program executed in these apparatuses.

2. Description of the Related Art

In recent years, a plurality of apparatuses of the same kind, for example, image processing apparatuses for processing images are connected through a network and are used in an environment in which data can be transmitted/received among each other. As a plurality of image processing apparatuses may have different functions, a technique has been developed in which one apparatus allows another apparatus to perform a function that the former does not have.

In order for one apparatus to allow another apparatus to perform a function in behalf of itself, a parameter for performing a requested function has to be set. Therefore, in a first technique, a setting window for setting a parameter is installed beforehand. In a second technique, information concerning a parameter necessary for the setting for performing a function is obtained from another apparatus, so that a setting window is generated according to a predetermined rule based on the obtained information, or a setting window held by another apparatus is received from another apparatus.

However, unfortunately, the first technique does not cope with an upgrade of another apparatus. Although the second technique can cope with an upgrade of another apparatus, the received setting window may not be matched with a function of one apparatus, making the setting difficult. For example, in a case where one apparatus does not have a function of processing a color image while another apparatus has a function of processing a color image and a monochrome image, the setting window held by another apparatus allows the parameter for processing a color image to be set, resulting in a mismatch with the ability of one apparatus.

### SUMMARY OF THE INVENTION

The present invention is made to solve the aforementioned problem. An object of the present invention is to provide an information processing apparatus that facilitates settings required to perform a function.

In order to achieve the aforementioned object, in accordance with an aspect of the present invention, an information processing apparatus includes: a request reception portion to receive a transmission request for a range of parameter necessary to execute a prescribed function from another information processing apparatus; an information obtaining portion to receive prescribed information related to another information processing apparatus; a determination portion to determine a range of parameter that can be set to execute the prescribed function, based on the prescribed information received from another information processing apparatus; a transmission portion to transmit the determined range to another information processing apparatus; and an execution portion to execute the prescribed function according to a parameter received from another information processing apparatus.

According to this aspect, a range of parameter that can be set to execute a prescribed function is determined based on prescribed information related to another information processing apparatus, and the determined range is transmitted to another information processing apparatus. Then, a prescribed function is executed according to a parameter received from another information processing apparatus. Therefore, a range of parameter that can be set is restricted based on prescribed information related to another information processing apparatus, so that a parameter that is applicable to the apparatus can be input in another information processing apparatus. As a result, it is possible to provide an information processing apparatus that facilitates settings necessary to execute a function.

In accordance with another aspect of the present invention, an information processing apparatus includes: a setting window obtaining portion to obtain from another information processing apparatus a setting window for setting a first parameter necessary for another information processing apparatus to execute a prescribed function; an alternative range determination portion to determine a range of the first parameter that can be set in the setting window, based on ability to execute a function of the apparatus itself a first parameter acceptance portion to accept the first parameter set in the setting window within the range determined for the first parameter; and a request transmission portion to transmit the accepted first parameter to another information processing apparatus for execution of the prescribed information.

According to this aspect, a range in which a first parameter necessary for another information processing apparatus to execute a prescribed function can be set is determined based on the ability to execute a function of the apparatus itself, thereby avoiding generation of data that cannot be executed by another information processing apparatus and avoiding execution of an unnecessary function by another information processing apparatus. As a result, excessive setting can be avoided. As a result, it is possible to provide an information processing apparatus that facilitates setting necessary to execute a function.

In accordance with a further aspect of the present invention, a proxy process execution method includes the steps of receiving a transmission request for a range of parameter necessary to execute a prescribed function from another information processing apparatus; receiving prescribed information related to another information processing apparatus; determining a range of parameter that can be set to execute the prescribed function, based on the prescribed information received from another information processing apparatus; transmitting the determined range to another information processing apparatus; and executing the prescribed function according to a parameter received from another information processing apparatus.

According to this aspect, it is possible to provide a proxy process execution method that facilitates setting necessary to execute a function.

In accordance with a still further aspect of the present invention, a proxy process execution method includes the steps of obtaining from another information processing apparatus a setting window for setting a first parameter necessary for another information processing apparatus to execute a prescribed function; determining a range of the first parameter that can be set in the setting window, based on ability to execute a function of an apparatus itself; accepting the first parameter set in the setting window within the range determined for the first parameter; and transmitting the accepted first parameter to another information processing apparatus for execution of the prescribed function.

According to this aspect, it is possible to provide a proxy process execution method that facilitates setting necessary to execute a function.

In accordance with yet another aspect of the present invention, a proxy process execution program causes a computer to execute the steps of: receiving a transmission request for a range of parameter necessary to execute a prescribed function from another information processing apparatus; receiving prescribed information related to another information processing apparatus; determining a range of parameter that can be set to execute the prescribed function, based on the prescribed information received from another information processing apparatus; transmitting the determined range to another information processing apparatus; and executing the prescribed function according to a parameter received from another information processing apparatus.

According to this aspect, it is possible to provide a proxy process execution program that facilitates setting necessary to execute a function.

In accordance with a further aspect of the present invention, a proxy process execution program causes a computer to execute the steps of: obtaining from another information processing apparatus a setting window for setting a first parameter necessary for another information processing apparatus to execute a prescribed function; determining a range of the first parameter that can be set in the setting window, based on ability to execute a function of an apparatus itself; accepting the first parameter set in the setting window within the range determined for the first parameter; and transmitting the accepted first parameter to another information processing apparatus for execution of the prescribed function.

According to this aspect, it is possible to provide a proxy process execution program that facilitates setting necessary to execute a function.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram schematically showing an information processing system as a whole in a first embodiment of the present invention.

FIG. 2 is an external perspective view of MFP.

FIG. 3 is a block diagram showing an exemplary hardware configuration of MFP.

FIG. 4 is a functional block diagram schematically showing functions of CPU of a proxy MFP in the first embodiment.

FIG. 5 shows exemplary parameters in a print function.

FIG. 6 is a first diagram showing an exemplary parameter determination table.

FIG. 7 is a second diagram showing an exemplary parameter determination table.

FIG. 8 is a flowchart illustrating an exemplary flow of a proxy function execution process.

FIG. 9 is a block diagram showing overall functions of CPU 101A of a requestor MFP 100A in a second embodiment.

FIG. 10 is a flowchart illustrating an exemplary flow of a process condition setting process.

FIG. 11 is a flowchart illustrating an exemplary flow of a proxy function parameter setting process.

FIG. 12 is a flowchart illustrating an exemplary flow of a normal function parameter setting process.

### DESCRIPTION OF THE PREFERRED EMBODIMENTS

In the following, embodiments of the present invention will be described with reference to the figures. In the following description, the same parts are denoted with the same reference characters. Their names and functions are also the same. Therefore, a detailed description thereof will not be repeated.

### First Embodiment

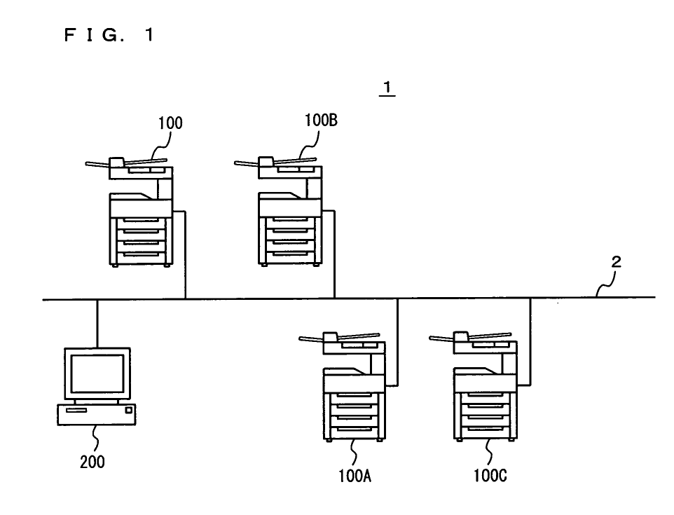

FIG. 1 is a diagram schematically showing an information processing system as a whole in a first embodiment of the present invention. Referring to FIG. 1, an information processing system 1 includes Multi Function Peripherals (referred to as MFP hereinafter) 100, 100A, 100B, 100C and a personal computer (referred to as PC hereinafter) 200, each connected to a network 2. In the present embodiment, MFPs 100, 100A, 100B, 100C will be described as an example of the information processing apparatus. However, in place of MFPs 100, 100A, 100B, 100C, for example, a scanner, a printer, a facsimile and the like may be employed as long as the apparatus includes a function of processing an image.

PC 200 as another example of the information processing apparatus is a general personal computer. The hardware configuration and function are well known and therefore a description thereof will not be repeated here. An image processing program is installed in PC 200. The image processing program is, for example, a character recognition program for recognizing characters in image data, a program for correcting the image quality of an image, a document management program for accumulating and managing image data, a data transmission program for transmitting image data by a communication method such as email transmission or file transfer, and the like. PC 200 has a function as a web server and transmits a web page in response to an inquiry from MFPs 100, 100A, 100B, 100C.

Network 2 is a local area network (LAN) and the form of connection can be wired or wireless. In addition, network 2 is not limited to a LAN and can be a wide area network (WAN), a Public Switched Telephone Network (PSTN), the Internet, and so on.

In information processing system 1 in the present embodiment, four MFPs 100, 100A, 100B, 100C may have the same functions or respectively different functions. Basically, each at least includes any of an image reading function of reading a document to output image data, an image processing function of processing image data, an image forming function for forming an image on a recording sheet such as paper, based on image data, a post-processing function of performing punched-hole processing, sorting processing and the like on a recording sheet having an image formed thereon, and a facsimile transmission/reception function.

In information processing system 1, for example, even if MFP 100 does not have a function, MFP 100 allows any one of other MFPs 100A, 100B, 100C or PC 200 that have the function to perform the function. Which apparatus has which function may be known by obtaining information concerning a function held by each apparatus from that apparatus in advance.

In the following description, MFP 100A allows MFP 100 to perform a function held by MFP 100, by way of example. In the following, MFP 100A which requests execution of a function will be referred to as a requestor MFP 100A (which corresponds to another image processing apparatus), MFP 100 which performs a function in behalf of requestor MFP 100A will be referred to as proxy MFP 100, and a function performed by proxy MFP 100 in response to the request will be referred to as a proxy function. In requestor MFP 100A, a parameter necessary for proxy MFP 100 to perform a proxy function needs to be set. Therefore, requestor MFP 100A requests proxy MFP 100 to transmit a range of parameters necessary for proxy MFP 100 to perform a proxy function. Proxy MFP 100 receiving the request transmits a range of parameters that can be set to perform a proxy function to requestor MFP 100A which has made the request. Here, transmitted to requestor MFP 100A is a range of parameters customized according to the ability of requestor MFP 100A.

Although a range of parameters itself may be transmitted, here, a setting window allowing parameters to be set in the customized range is transmitted, by way of example. In the present embodiment, MFPs 100, 100A, 100B, 100C and PC 200 each may serve as a web server and may serve as a client communicating with another web server. In a case where MFP 100A is requestor MFP 100A and MFP 100 is proxy MFP 100, proxy MFP 100 is a web server and requestor MFP 100A is a client.

Proxy MFP 100 serving as a web server has a setting window stored as a web page in HDD 116 for setting a parameter necessary to execute a function held by proxy MFP 100. The URL of web page of the setting window is transmitted in advance to other MFPs 100A, 100B, 100C or the URL is transmitted in response to the inquiry from them. Requestor MFP 100A has a browser program installed therein and, when a function requested to be performed is specified, receives the setting window stored by proxy MFP 100, based on the URL of the setting window corresponding to the specified function, among the URLs received from proxy MFP 100.

This setting window is described with a markup language and includes a command to transmit a parameter when the parameter is input. Therefore, if a browser program is installed in MFP 100, requestor MFP 100A can display the setting window received from proxy MFP 100 and transmit the parameter input therein to proxy MPF 100.

Although MFPs 100, 100A, 100B, 100C have respectively different functions, assuming here that MFP 100 has all functions, a configuration of MFP 100 will be described.

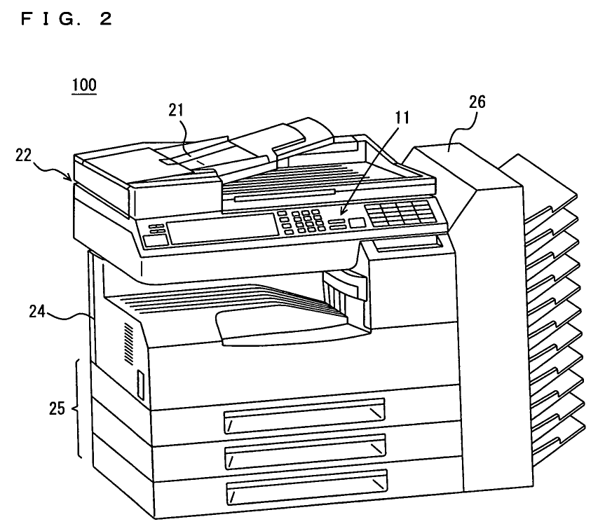

FIG. 2 is an external perspective view of MFP 100. Referring to FIG. 2, MFP 100 includes an automatic document feeder (ADF) 21, an image reading portion 22, an image formation portion 24, a paper-feeding portion 25, and a post-processing portion 26. ADF 21 conveys a document having a number of pages placed on a document plate, one by one in order, to image reading portion 22. Image reading portion 22 optically reads image information such as photographs, characters and pictures from the document to obtain image data. Image formation portion 24 receives image data to print an image on a recording sheet such as a sheet of paper based on the image data. Paper-feeding portion 25 stores recording sheets and supplies the stored sheets one by one to image formation portion 24. Post-processing portion 26 discharges a recording sheet having an image formed thereon. Post-processing portion 26 has a plurality of paper-discharge trays to allow recording sheets to be sorted and discharged. Post-processing portion 26 additionally includes a punched-hole processing portion and a stapling processing portion to allow a punched-hole process or a stapling process to be performed on the discharged recording sheet. In addition, MFP 100 includes an operation panel 11 on the top as a user interface with a user.

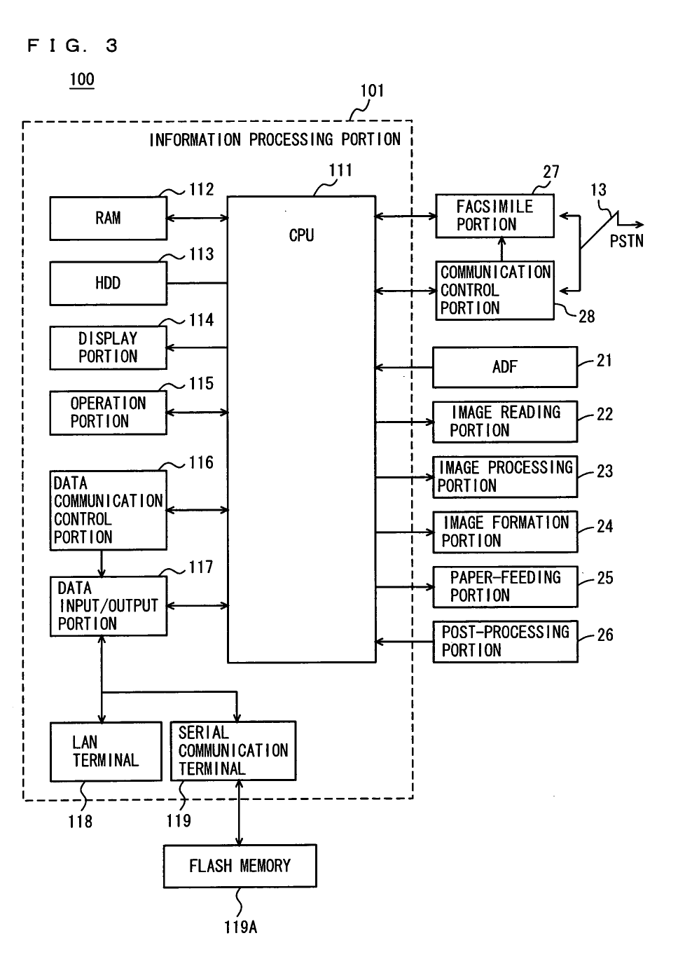

FIG. 3 is a block diagram showing an exemplary hardware configuration of MFP 100. With reference to FIG. 3, MFP 100 includes an information processing portion 101, a facsimile portion 27, a communication control portion 28, ADF 21, image reading portion 22, image processing portion 23, image formation portion 24, paper-feeding portion 25, and post-processing portion 26. Information processing portion 101 includes a central processing unit (CPU) 111, a RAM (Random Access Memory) 112 used as a work area for CPU 111, a hard disk drive (HDD) 113 for storing data in a non-volatile manner, a display portion 114, an operation portion 115, a data communication control portion 116, and a data input/output portion 117. CPU 111 is connected to each of data input/output portion 117, data communication control portion 116, operation portion 115, display portion 114, HDD 113 and RAM 112 to control the entire information processing portion 101. CPU 111 is also connected to each of facsimile portion 27, communication control portion 28, ADF 21, image reading portion 22, image processing portion 23, image formation portion 24, paper-feeding portion 25 and post-processing portion 26 to control the entire MFP 100.

Image processing portion 23 is controlled by CPU 111 to perform image processing on image data based on an instruction from CPU 111. Image data includes image data output by image reading portion 22 reading a document, image data received from any of other MFPs 100A, 100B, 100C and PC 200 through data input/output portion 117, and image data stored in HDD 113. Image processing is, for example, an enlargement process of enlarging an image, a reduction process of reducing an image, a synthesis process of synthesizing a plurality of images to generate one image, a rotation process of rotating an image to change the direction, a process of recognizing a character, a process of correcting the image quality of an image, and the like.

Display portion 114 is a display such as a liquid crystal display (LCD) or an organic ELD (Electro-Luminescence Display) to display an instruction menu for a user, information about the obtained image data, and the like. Operation portion 115 includes a plurality of keys and accepts a variety of instructions, inputs of data such as characters and numerals by the user's operation corresponding to a key. Operation portion 115 further includes a touch panel provided on display portion 114. Display portion 114 and operation portion 115 constitute operation panel 11.

Data communication control portion 116 is connected to data input/output portion 117. Data communication control portion 116 controls data input/output portion 117 under an instruction from CPU 111 to transmit/receive data to/from external equipment connected to data input/output portion 117. Data input/output portion 117 has an LAN terminal 118 as an interface for communication with communication protocols such as TCP (Transmission Control Protocol) or FTP (File Transfer Protocol) and a USB (Universal Serial Bus) terminal 119.

When a LAN cable for connecting to network 2 is connected to LAN terminal 118, data communication control portion 116 controls data input/output portion 117 to communicate with MFPs 100A, 100B, 100C and PC 200 connected through LAN terminal 118.

When equipment is connected to serial communication terminal 119, data communication control portion 116 controls data input/output portion 117 and communicates with the connected equipment for data input/output. A flash memory 119A may be connected to serial communication terminal 119. A proxy process execution program which will be described later is stored in flash memory 119A. CPU 111 controls data communication control portion 116 to read the proxy process execution program from flash memory 119A and store the read proxy process execution program into RAM 112 for execution.

Here, a recording medium having the proxy process execution program stored therein is not limited to flash memory 119A and may be a medium such as a flexible disk, a cassette tape, an optical disk (CD-ROM (Compact Disc-Read Only Memory)/MO (Magnetic Optical Disc/MD (Mini Disc)/DVD (Digital Versatile Disc)), an IC card (including a memory card), an optical card, or a semiconductor memory such as a mask ROM, EPROM (Erasable Programmable ROM), or EEPROM (Electronically EPROM). Alternatively, CPU 111 may download a proxy process execution program from a computer connected to network 2 for storage into HDD 113, or a computer may write a proxy process execution program into HDD 113, so that the proxy process execution program stored in HDD 113 may be loaded into RAM 112 and executed by CPU 111. The program referred to herein includes not only a program directly executable by CPU 111 but also a source program, a compressed program, an encrypted program, and the like.

Facsimile portion 27 is connected to PSTN 13 to transmit facsimile data to PSTN 13 or receive facsimile data from PSTN 13. Facsimile portion 27 stores the received facsimile data into HDD 113 and, in addition, converts the received facsimile data into print data that allows for printing in image formation portion 24 and outputs the converted data to image formation portion 24. Accordingly, image formation portion 24 prints the facsimile data received from facsimile portion 27 on a recording sheet. In addition, facsimile portion 27 converts the data stored in HDD 113 into facsimile data and transmits the converted data to a FAX connected to PSTN 13.

MFPs 100, 100A, 100B, 100C each include at least any of image reading portion 22, image processing portion 23, image formation portion 24 and facsimile portion 27. Therefore, some of MFPs 100, 100A, 100B, 100C may not have all of ADF 21, image reading portion 22, image processing portion 23, image formation portion 24, paper-feeding portion 25, post-processing portion 26 and facsimile portion 27. The functions of MFPs 100, 100A, 100B, 100C vary depending on which of ADF 21, image reading portion 22, image processing portion 23, image formation portion 24, paper-feeding portion 25, post-processing portion 26 and facsimile portion 27 is included.

In the example described above, image processing portion 23 includes an enlargement process, a reduction process, a synthesis process, a rotation process, a character recognition process and an image quality correction process. However, image processing portion 23 may execute at least one of an enlargement process, a reduction process, a synthesis process, a rotation process, a character recognition process and an image quality correction process. Therefore, among those of MFPs 100, 100A, 100B, 100C which include image processing portion 23, the functions may vary depending on which of an enlargement process, a reduction process, a synthesis process, and a rotation process can be executed.

In the example described above, post-processing portion 26 includes a sorting function, a stapling function and a punching function. However, post-processing portion 26 may include at least one of these functions. Therefore, some of MFPs 100, 100A, 100B, 100C may not have all of a sorting function, a stapling function and a punching function. Thus, among those of MFPs 100, 100A, 100B, 100C which include post-processing portion 26, the functions may vary depending on which of a sorting function, a stapling function and a punching function is included.

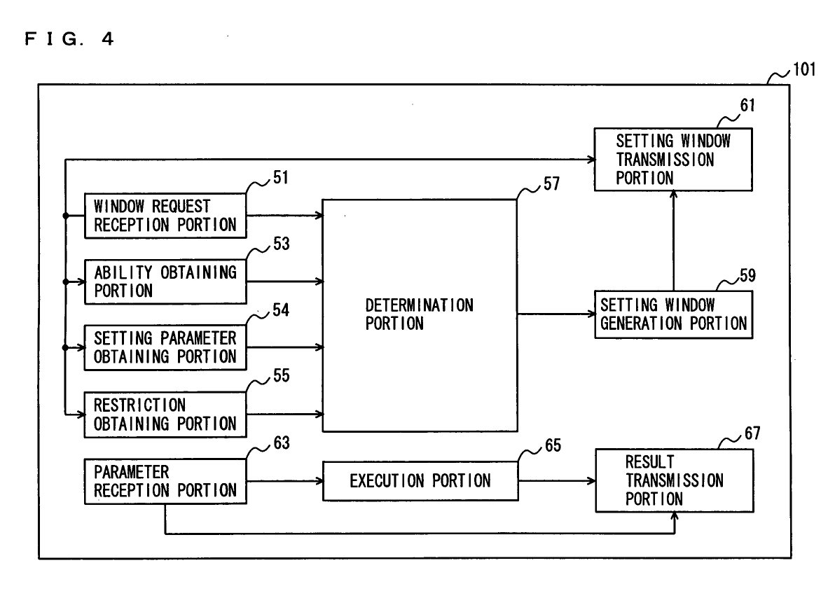

FIG. 4 is a functional block diagram showing overall functions of CPU 101 included in proxy MFP 100 in the first embodiment. Referring to FIG. 4, CPU 101 includes a window request reception portion 51 for receiving a transmission request for a setting window from requestor MFP 100A, an ability obtaining portion 53 obtaining ability information from requestor MFP 100A, a setting parameter obtaining portion 54 obtaining a parameter set in requestor MFP 100A, a restriction obtaining portion 55 obtaining restriction information from requestor MFP 100A, a determination portion 57 determining a range of parameters, a setting window generation portion 59 generating a setting window, a setting window transmission portion 61 transmitting a setting window to requestor MFP 100A, a parameter reception portion 63 receiving a parameter from requestor MFP 100A, an execution portion 65 executing a function according to a parameter, and a result transmission portion 67 transmitting an execution result.

Window request reception portion 51 receives a request to transmit a setting window from requestor MFP 100A. The request includes information of the location on network 2 of the setting window stored in HDD 113. The location information is, for example, URL. Specifically, when data communication control portion 116 receives a transmission request for a setting window from MFP 100A connected through network 2, window request reception portion 51 receives the transmission request for a setting window from data communication control portion 116. Here, data communication control portion 116 receives an apparatus ID (apparatus identification information) for identifying requestor MFP 100A which has transmitted the transmission request for a setting window, so that parameter reception portion 63 obtains the apparatus ID of requestor MFP 100A from data communication control portion 116. Here, the location information on network 2 which is assigned to requestor MFP 100A, for example, IP (Internet Protocol) address or MAC (MediAccess Control) address is obtained as an apparatus ID. Window request reception portion 51 outputs the transmission request for a setting window to determination portion 57 and outputs the apparatus ID to ability obtaining portion 53, setting parameter obtaining portion 54, restriction obtaining portion 55 and setting window transmission portion 61.

Ability obtaining portion 53 obtains ability information from requestor MFP 100A. The ability information includes the kinds of function held by requester MFP 100A and performance thereof. For example, in a scanner function of scanning a document and outputting image data, the kind of function is a scanner function and the performance is scan resolution, color or monochrome, a document size that can be scanned, an output data format, and the like. Ability obtaining portion 53 transmits a transmission request for ability information to requestor MFP 100A identified by the apparatus ID input from window request reception portion 51 and receives the ability information from requester MFP 100A. Here, the ability information of other apparatuses, namely MFPs 100A, 100B, 100C and PC 200 may be stored in HDD 113 so that the ability information of a requestor apparatus, that is, here, requester MFP 100A may be read from HDD 113. Ability obtaining portion 53 outputs the ability information of requester MFP 100A to determination portion 57.

Setting parameter obtaining portion 54 obtains a parameter (referred to as a setting parameter hereinafter) set for a function set to be executed in requester MFP 100A. Setting parameter obtaining portion 54 transmits a transmission request for a setting parameter to requestor MFP 100A identified by the apparatus ID input from window request reception portion 51 and receives the setting parameter from requestor MFP 100A. Setting parameter obtaining portion 54 outputs the setting parameter to determination portion 57.

Restriction obtaining portion 55 obtains restriction information from requester MFP 100A. The restriction information is information that specifies a function of which execution is restricted in requestor MFP 100A, among the functions held by requestor MFP 100A. The restriction information includes information that directly specifies the function of which execution is restricted and, in addition, information that indirectly restricts execution. The information that directly specifies the function of which execution is restricted is, for example, information for a user who logs in to requester MFP 100A to specify a function of forming an image in color, in a case where image formation in color is prohibited. The information that indirectly restricts execution is, for example, a security level. The security level is a level for selecting an encryption scheme or a communication protocol, and the security level decides an executable encryption scheme or communication protocol. The security level prohibits the execution of a function of encrypting in an unselected encryption scheme or a function of communicating in an unselected communication protocol.

Restriction obtaining portion 55 transmits a transmission request for restriction information to requestor MFP 100A identified by the apparatus ID input from window request reception portion 51 and receives the restriction information from requestor MFP 100A. Here, restriction information of other apparatuses, namely, MFPs 100A, 100B, 100C and PC 200 may be stored in advance in HDD 113 so that the restriction information of a requestor apparatus, here, requestor MFP 100A may be read from HDD 113. Restriction obtaining portion 55 outputs the restriction information of requestor MFP 100A to determination portion 57.

Determination portion 57 reads from HDD 113 a setting window specified by the URL included in the transmission request for a setting window input from window request reception portion 51. At least one setting window is stored for a function executable by proxy MFP 100 and defines the kind of parameters necessary to execute the function and the range thereof. Furthermore, the setting window is displayed on display portion 114 by the browsing program to allow the defined parameters to be input in the defined range.

Determination portion 57 changes the range of parameters defined by the setting window specified by URL based on the ability information of requestor MFP 100A input from ability obtaining portion 53. Specifically, for the data on which a function within the range of ability of requestor MFP 100A has been executed, the range of parameters is restricted so that the setting of the function performed by proxy MFP 100 acting as a proxy do not become excessive. In addition, the setting of the function performed by proxy MFP 100 as a proxy is made such that the range of parameters is restricted so that data on which proxy MFP 100 has executed the function can be executed by a function in a range of ability of requestor MFP 100A.

In addition, determination portion 57 changes the range of parameters defined by the setting window based on the setting parameters set in requestor MFP 100A which are input from setting parameter obtaining portion 54. Specifically, for the data that has been executed according to the setting parameters set in requestor MFP 100A, the range of parameters is restricted so that the setting of the function performed by proxy MFP 100 as a proxy does not become excessive. In addition, the range of parameters is restricted so that the data on which proxy MFP 100 has executed a proxy function does not become data on which requester MFP 100A cannot execute a function.

A specific example of changing a range of parameters will now be described. FIG. 5 shows exemplary parameters in a print function. FIG. 5 shows a range of parameters in a case where the kind of parameter in the print function is a color mode. The parameters include three options (choices) of color, gray and monochrome, and the range of parameters can be defined by these three options. The respective attributes are defined for three parameters. For the parameter “color”, an attribute “Colordata” is defined indicating that processible data is color data. For the parameter “gray”, an attribute “Graydata” is defined indicating that processible data is singled-colored multi-value data. For the parameter “monochrome”, an attribute “BWdata” is defined indicating that processible data is binary data.

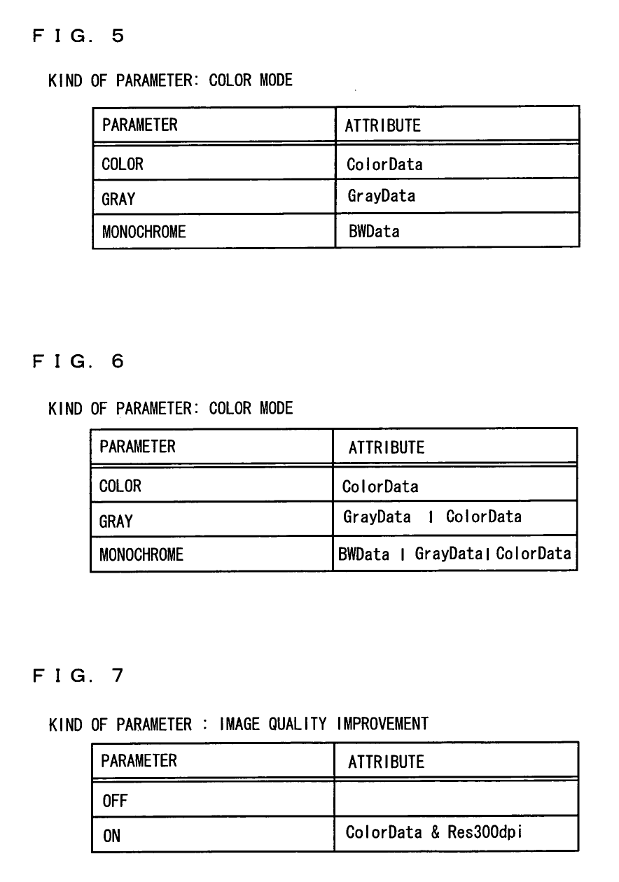

FIG. 6 is a first diagram showing an exemplary parameter determination table. FIG. 6 shows a parameter determination table in the case where the kind of parameter in the print function is the color mode. It is noted that the symbol “|” in the figure represents OR. The parameter determination table defines an attribute selectable for each parameter. The attribute “Colordata” is defined for the parameter “color,” the attribute “Graydata” or “Colordata” is defined for the parameter “gray,” and the attribute “BWdata,” “Graydata” or “Colordata” is defined for the parameter “monochrome.”

This parameter determination table is used to change the range of parameters based on the ability information of requestor MFP 100A. The performance of the scanner function of the ability information of requestor MFP 100A is any one of color data, single-colored multi-value data and binary data as a data format that can be output. The range of parameters is defined based on the performance of the scanner function. If the data format that can be output is color data as the performance of the scanner function in the ability information of requestor MFP 100A, the attribute “Colordata” is determined which corresponds to the data format of color data. Then, only the parameters for which “Colordata” is defined as the attributes are selected in the parameter determination table. Therefore, the parameters “color,” “gray” and “monochrome” are selected. If the data format that can be output is single-colored multi-value data as the performance of the scanner function in the ability information of requestor MFP 100A, the attribute “Graydata” is determined which corresponds to the data format of single-colored multi-value data. Then, only the parameters for which “Graydata” is defined as the attributes are selected. Therefore, the parameters “gray” and “monochrome” are selected. If the data format that can be output is binary data as the performance of the scanner function in the ability information of requestor MFP 100A, the attribute “BWdata” is determined which corresponds to the data format of binary data. Then, only the parameter for which “BWdata” is defined as the attribute is selected in the parameter determination table. Therefore, the parameter “monochrome” is selected.

FIG. 7 is a second diagram showing an exemplary parameter determination table. FIG. 7 shows a parameter determination table in a case where the kind of parameter in an image processing function is image quality improvement. It is noted that the symbol “&” in the figure represents AND. The parameter determination table shown in FIG. 7 defines an attribute for each parameter. No attribute is set for a parameter “OFF” and attributes “Colordata” and “Res300 dpi” are defined for a parameter “ON.” Here, Res300 dpi indicates that the resolution is 300 dpi.

This parameter determination table is used to change the range of parameters that can be set in requestor MFP 100A from the setting parameters set for the function performed by requestor MFP 100A. More specifically, the range of parameters is defined based on the setting parameters set for the scanner function in requester MFP 100A. Supposing that the scanner function is set as a function performed in requestor MFP 100A, and color is set as the setting parameter of the data format and 300 dpi is set as the setting parameter of the scan resolution, these setting parameters satisfy the condition of the attribute “Colordata&Res300 dpi.” Therefore, the parameters “OFF” and “ON” are selected. On the other hand, if the setting parameters set in requestor MFP 100A do not satisfy the condition of the attribute “Colordata&Res300 dpi”, for example, if the setting parameter of the scan resolution is smaller than 300 dpi, only the parameter “OFF” is selected.

Returning to FIG. 4, determination portion 57 further changes the range of parameters defined in the setting window, based on the restriction information input from restriction obtaining portion 55. Specifically, the range of parameters is restricted so that the process prohibited from being performed in requestor MFP 100A is not performed in proxy MFP 100. For example, in a case where a user who logs in to requestor MFP 100A is prohibited from image formation in color and restriction information that specifies the color print function is input, the range of three parameters of color, gray and monochrome is changed to the range of two parameters of gray and monochrome. Furthermore, in a case where FAX transmission is not permitted in requester MFP 100A, the range of two parameters “ON” and “OFF” as the kinds of FAX transmission in the data transmission function is changed to the range of one parameter “OFF.” In addition, when the security level is set high in requestor MFP 100A, the range of parameters that allows execution of a process that does not satisfy the security level in requestor MFP 100A is restricted. For example, in a case where the security level is set to a prescribed level or higher in requestor MFP 100A, FTP transmission is not permitted in the data transmission function in order to ensure that security level. In this case, the range of two parameters “ON” and “OFF” as the kinds of FTP transmission in the data transmission function is changed to the range of one parameter “OFF.” Alternatively, the range of parameters is restricted such that two kinds of parameters of FTP transmission and WebDAV (Web-based Distributed Authoring and Versioning) transmission are changed to only one kind, namely WebDAV transmission. In addition, in the encryption function, for different kinds of parameters corresponding to different kinds of encryption methods, the range of parameters is restricted such that only an encryption method that ensures the security level can be set.

A change based on the ability information, a change based on the setting parameter, and a change based on the restriction information are set valid, whichever the change is based on. Therefore, in some cases, all of a change based on the ability information, a change based on the setting parameter, and a change based on the restriction information are valid. Here, a description will be made to an example in which all of a change based on the ability information, a change based on the setting parameter and a change based on the restriction information are combined. However, any one of them or a combination of two is possible.

Determination portion 57 determines a range of parameters defined by the setting window as a range of parameters after change and outputs the determined range of parameters and the setting window to setting window generation portion 59.

Setting window generation portion 59 generates a new setting window in which the range of parameters defined in the setting window input from determination portion 57 has been changed to the range of parameters determined by determination portion 57. Then, the new setting window is output to setting window transmission portion 61. Setting window transmission portion 61 transmits the new setting window to requester MFP 100A identified by the apparatus ID input from window request reception portion 51. In the new setting window, the range of parameters defined therein has been changed based on the ability information of requestor MFP 100A, the restriction information, and the setting parameters set in requestor MFP 100A.

Parameter reception portion 63 receives from MFP 100A the parameters set based on the setting window in requestor MFP 100A and the request to execute a function. Specifically, when data communication control portion 116 receives the parameters and the execution request from MFP 100A connected through network 2, parameter reception portion 63 receives the parameters and the execution request from data communication control portion 116. The execution request includes a function ID for specifying a function to be executed. In place of a function ID, the setting window itself which was previously transmitted by setting window transmission portion 61 or a window ID for specifying the setting window may be included in the execution request. Data communication control portion 116 receives the apparatus ID for identifying requestor MFP 100A which has transmitted the parameters, so that parameter reception portion 63 obtains the apparatus ID of requester MFP 100A from data communication control portion 116. This is to reply an execution result as described later. Upon reception of the execution request, parameter reception portion 63 outputs the parameters and the function ID to execution portion 65 and outputs the apparatus ID to result transmission portion 67. In addition, parameter reception portion 63 may receive data to be processed together with the parameters. In the case where data to be processed is received together with the parameters, that data is output together with the parameters to execution portion 65.

Execution portion 65 executes the function specified by the function ID according to the input parameters. In the case where data is input together with the parameters from parameter reception portion 63, the function is executed on the data as a target to be processed. Execution portion 65 outputs data generated by executing the function to result transmission portion 67. Result transmission portion 67 transmit the input data to requestor MFP 100A identified by the apparatus ID input from parameter reception portion 63.

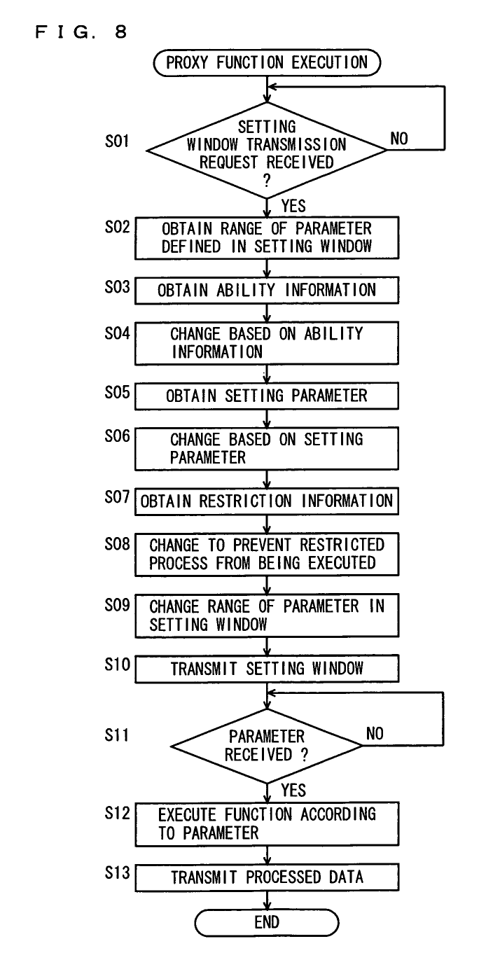

FIG. 8 is a flowchart illustrating an exemplary flow of a proxy function execution process. The proxy function execution process is a process performed by CPU 101 by CPU 101 included in proxy MFP 100 executing the proxy process execution program. Referring to FIG. 8, CPU 101 determines whether or not a transmission request for a setting window is received (step S01). The setting window is a window for setting the parameters necessary to execute the function held by proxy MFP 100. The process stands by until the transmission request for a setting window is received (NO in step S01). If the transmission request for a setting window is received, the process proceeds to step S02. In other words, the proxy function execution process is a process performed on condition that the transmission request for a settings window is received.

In step S02, the range of parameters defined in the setting window is obtained. Then, the ability information of requester MFP 100A which has transmitted the transmission request for a setting window is obtained (step S03). Requestor MFP 100A is requested to transmit the ability information, and the ability information is then received from requestor MFP 100A.

In step S04, the range of parameters is changed based on the obtained ability information. Specifically, the range of parameters is restricted so that data on which proxy MFP 100 has executed a function as a proxy can be executed with the ability of requestor MFP 100A. For example, in a case where a proxy function is a scanner function and where the ability of image formation portion 24 of requestor MFP 100A only allows image formation in a single color, the parameter for the setting of outputting color data is deleted from the range. Furthermore, for the data that has been executed with the function within the ability of requester MPF 100A, the range of parameters is restricted so that the setting of the function executed by proxy MFP 100 does not become excessive. For example, in a case where a proxy function is a print function and where the ability of image reading portion 22 of requestor MFP 100A only allows monochrome data output, the parameter for setting image formation in color is deleted from the range.

In step S05, the setting parameter set for the function to be executed in requestor MFP 100A is obtained. Requestor MFP 100A is requested to transmit the setting parameter, and the setting parameter is then received from requestor MFP 100A.

In step S06, the range of parameters is changed based on the obtained setting parameters. Specifically, for the data on which requestor MFP 100A has executed a function according to the setting parameters, the range of parameters is restricted so that the setting of the proxy function executed by proxy MFP 100 does not become excessive. For example, in a case where a proxy function is a print function and where the scanner function is set to the scanning not in a color mode but in a monochrome mode in requestor MFP 100A, the parameter for setting image formation in color is deleted from the range. Furthermore, in a case where a proxy function is a scanner function and where monochrome print is set in image formation portion 24 of requester MFP 100A, the parameter for setting color data outputting is deleted from the range.

In step S07, the restriction information to restrict execution of a process in requestor MFP 100A is obtained. Requestor MFP 100A is requested to transmit the restriction information, and the restriction information is then received from requester MFP 100A.

In step S08, the range of parameters is changed based on the obtained restriction information. Specifically, the range of parameters is restricted so that the process prohibited from being executed in requestor MFP 100A is not executed in proxy MFP 100. For example, in a case where the operator of requestor MFP 100A is not authorized to do color printing, the parameter for setting image formation in color in requestor MFP 100A is deleted from the range. Furthermore, in a case where the security level is set high in requestor MFP 100A, an encryption process that does not satisfy the security level or a process of transmitting data in a data transmission method that does not satisfy the security level is not allowed to be set. For example, when the security level exceeds a prescribed level and execution of FTP transmission is prohibited, the parameter for setting FTP transmission is deleted from the range.

In the next step S09, the range of parameters defined in the setting window requested to be transmitted in step S01 is changed to the range of parameters changed in step S04, step S06 and step S08. Then, the setting window having the range of parameters changed is transmitted to requestor MFP 100A which has transmitted the transmission request for a setting window (step S10).

Then, the process stands by until parameters are received (NO in step S11). If a parameter is received (YES in step S11), the process proceeds to step S12. Here, data may be received together with a parameter.

In step S12, the function corresponding to the setting window transmitted in step S10 is executed according to the parameter received in step S11. Here, data may be received together with a parameter in step S11, and if data is received, the function is executed on the data as a target to be processed. Then, the processed data on which the function has been executed is transmitted to requestor MFP 100A (step S13).

As described above, when receiving a transmission request from requestor MFP 100A for a setting window for setting a parameter set to execute a function, proxy MFP 100 in the first embodiment transmits a setting window after changing the range of parameters defined by the setting window based on the ability information of requester MFP. Therefore, such a setting can be avoided that causes data on which proxy MFP 100 has executed a function as a proxy to become data that cannot be executed with the ability of requestor MFP 100A. In addition, for the data that has been executed with the function within the ability of requestor MFP 100A, it is avoided that the setting for a function to be executed by proxy MFP 100 is set excessively.

In addition, proxy MFP 100 transmits the setting window having the range of parameters changed based on the setting parameters set to execute a function to be executed in requestor MPF 100A. Therefore, for the data that has been executed according to the setting parameters set for requestor MPF 100A, it is avoided that the setting for a function to be executed by proxy MFP 100 as a proxy is set excessively. Furthermore, such a setting can be avoided that causes the data on which proxy MFP 100 has executed a proxy function to become data on which requestor MFP 100A cannot execute a function according to the setting parameters.

Moreover, proxy MFP 100 transmits the setting window having the range of parameters changed based on the restriction information to restrict execution of a process in requestor MFP 100A. Therefore, a process prohibited from being executed in requestor MFP 100A is not allowed to be executed in proxy MFP 100. Furthermore, when the security level is set high in requester MFP 100A, a process that does not satisfy the security level in requestor MFP 100A is not allowed to be executed.

### Second Embodiment

In information processing system 1 in the first embodiment, the range of parameters in the setting window is changed in a proxy MFP. In an information processing system 1A in a second embodiment, the range of parameters in the setting window received from a proxy MFP is changed in a requester MFP. In the following, differences from the information processing system in the first embodiment will mainly be described.

In the following description, similar to the description in the first embodiment, requestor MFP 100A requesting execution of a function and proxy MFP 100 executing a proxy function in behalf of requestor MFP 100A will be described by way of example.

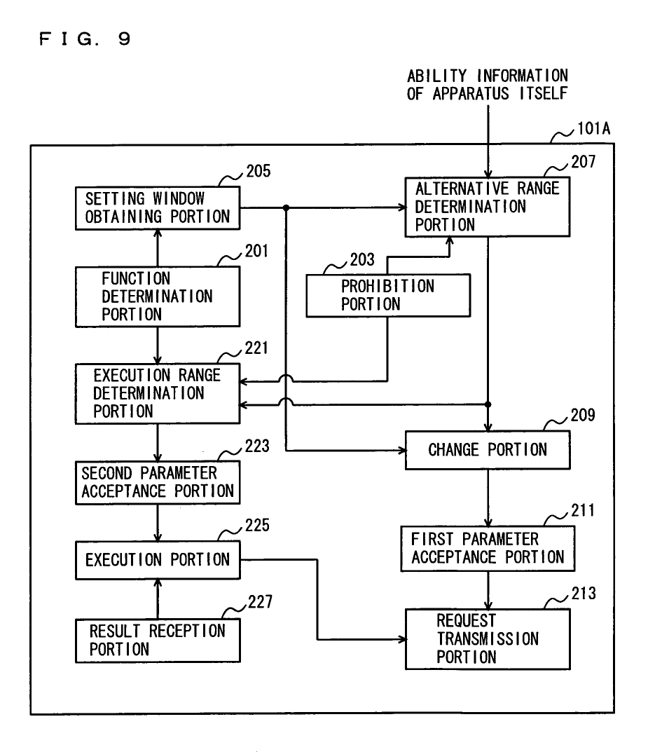

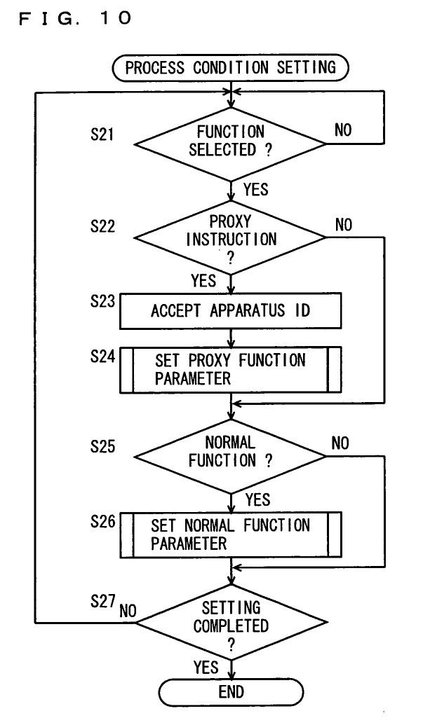

FIG. 9 is a block diagram showing an overall function of a CPU 101A included in requestor MFP 100A in the second embodiment. Referring to FIG. 9, CPU 101A includes a function determination portion 201 for determining a function to be executed, a prohibition portion 203 prohibiting execution of a function, a setting window obtaining portion 205 obtaining a setting window from proxy MFP 100, a change portion 209 changing a range of first parameter defined by a setting window, a first parameter acceptance portion 211 for accepting a first parameter, an execution range determination portion 221 for determining a range of second parameter for a function to be executed by the apparatus itself, a second parameter acceptance portion 223 accepting a second parameter, an execution portion 225 executing a function, and a result reception portion 227 receiving a result of execution of a function from proxy MFP 100.

Function determination portion 201 accepts designation of a function to be executed. Function determination portion 201 displays a function setting window on display portion 114 for displaying a function ID for identifying a function executable in the apparatus itself, that is, requestor MFP 100A, and a function ID for identifying a function executable by other apparatuses MFPs 100, 100B, 100C and PC 200. Then, when the user specifies a function ID on operation portion 115, the function identified by the specified function ID is accepted as a function to be executed. As for the functions held by other apparatuses MFPs 100, 100B, 100C and PC 200, the function information is collected from other apparatuses MFPs 100, 100B, 100C and PC 200 and then stored in advance.

Function determination portion 201 outputs the function ID for specifying the function to execution range determination portion 221, if the specified function is a function held by the apparatus itself, and outputs the function ID of the function and an apparatus ID for identifying an apparatus allowed to execute the function to setting window obtaining portion 205, if the specified function is a function held by other apparatuses, namely MFPs 100, 100B, 100C and PC 200. If a plurality of apparatuses can execute the same function, in addition to designation of a function, an apparatus which is to execute the function is designated. Here, an apparatus having the highest performance for the function may automatically be determined.

Prohibition portion 203 outputs a prohibition signal to execution range determination portion 221 and change portion 209, if a function prohibited from being executed is set in requestor MFP 100A. The prohibition signal includes a function ID for identifying a function prohibited from being executed. For example, the operator of requestor MFP 100A is prohibited from image formation in color, FTP transmission is prohibited, or the security level is set high and an encryption process with a low encryption level is prohibited.

Setting window obtaining portion 205 transmits the URL of the setting window identified by the function ID to proxy MFP 100 identified by the apparatus ID input from function determination portion 201, and then receives the setting window. Then, the received setting window is output to an alternative range determination portion 207 and change portion 209.

Alternative range determination portion 207 changes the range of parameters defined in the setting window input from setting window obtaining portion 205 based on the ability information of the apparatus itself. Specifically, the range of parameter is restricted so that the data on which proxy MFP 100 has executed a function as a proxy does not become data that cannot be executed with the ability of requester MFP 100A. Furthermore, for the data that has been executed with the function within the ability of requestor MFP 100A, the range of parameters is restricted so that the setting of a proxy function executed by proxy MFP 100 does not become excessive. Furthermore, when a prohibition signal is input from prohibition portion 203, alternative range determination portion 207 restricts the range of parameters so that the function prohibited from being executed is not executed in proxy MFP 100. Then, the changed range of parameters is output to change portion 209 and execution range determination portion 221.

Change portion 209 generates a new setting window in which the range of parameters defined by the setting window input from setting window obtaining portion 205 is changed to the range of parameters input from alternative range determination portion 207. Then, the new setting window is output to first parameter acceptance portion 211.

First parameter acceptance portion 211 displays the new setting window input from change portion 209 on display portion 114. Then, the parameter input to operation portion 115 by the user according to the setting window is accepted as a first parameter. Then, the accepted first parameter is output to request transmission portion 213.

Execution range determination portion 221 receives a function ID from function determination portion 201, receives the changed range of parameters from alternative range determination portion 207, and receives a prohibition signal from prohibition portion 203. Execution range determination portion 221 determines the range of parameters necessary to execute the function identified by the function ID, based on the changed range of parameters. Specifically, for the data that has been executed by proxy MFP 100 according to the first parameter, the range of parameters is restricted so that the setting for the function executed by requestor MFP 100A does not become excessive. Furthermore, the range of parameters is restricted such that the data on which a proxy function to be executed by proxy MFP 100 has been executed does not become data that cannot be executed with the ability of requestor MFP 100A.

In addition, when a prohibition signal is input from prohibition portion 203, execution range determination portion 221 determines the range of parameters necessary to execute a function identified by a function ID so that the function prohibited from being executed is not performed in requestor MFP 100A. Then, the changed range of parameters and the function ID are output to second parameter acceptance portion 223.

Second parameter acceptance portion 223 displays the parameter setting window identified by the function ID on display portion 114. Then, the parameter input to operation portion 115 by the user according to the setting window, that is, the parameter within the changed range of parameters input from execution range determination portion 221 is accepted as a second parameter. Then, the accepted second parameter and the function ID are output to execution portion 225.

Execution portion 225 executes the function identified by the function ID input from second parameter acceptance portion 223, according to the second parameter. In addition, if data is input from result reception portion 227, execution portion 225 executes a function on that data as a target to be processed. If a proxy function to be executed by proxy MFP 100 follows the executed function, execution portion 225 outputs the data that has been processed to request transmission portion 213.

Request transmission portion 213 transmits the first parameter to proxy MFP 100A. Here, if data is input from execution portion 225, that data is transmitted together with the first parameter to proxy MFP 100. Upon reception of the first parameter, proxy MFP 100 executes a function according to the first parameter and thereafter transmits the data to requestor MFP 100A. Result reception portion 227 receives the data transmitted by proxy MFP 100. Result reception portion 227 outputs the received data to execution portion 225.

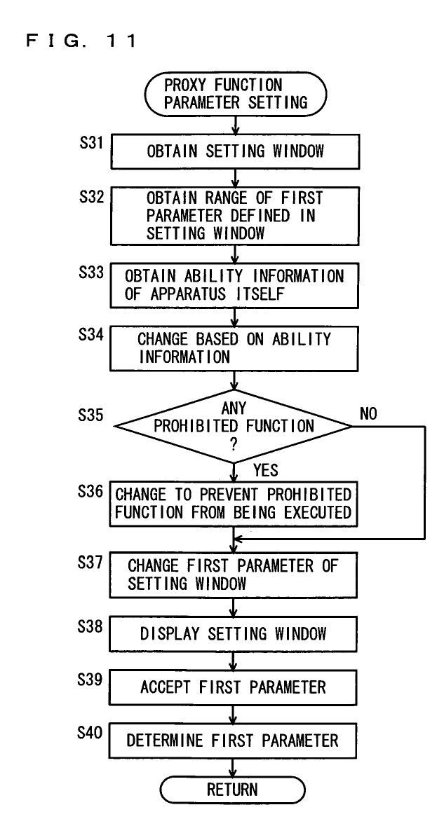

FIG. 10 is a flowchart illustrating an exemplary flow of a process condition setting process. The process condition setting process is a process performed by CPU 101A by CPU 101A included in requestor MFP 100A in the second embodiment executing the proxy process execution program.

Referring to FIG. 10, CPU 101A determines whether or not a function is selected (step S21). The process stands by until a function specified for execution is selected (NO in step S21), and when a function is selected, the process proceeds to step S22. In other words, the process condition setting process is a process performed on condition that a function is selected. Then, it is determined whether or not an instruction to cause another apparatus to perform the selected function as a proxy is accepted (step S22). If an instruction to cause another apparatus to act as a proxy is accepted, the process proceeds to step S23, and if not, the process proceeds to step S25.

In step S23, an apparatus ID of an apparatus as a proxy is accepted. Here, the apparatus ID of MFP 100 is accepted, by way of example. Then, a proxy function parameter setting process is performed, and the process then proceeds to step S25. The proxy function parameter setting process will be described later.

In the next step S25, it is determined whether or not the function selected in step S21 is a normal function to be executed by the apparatus itself. If a normal function, the process proceeds to step S26, and if not, the process proceeds to step S27. In step S26, a normal function parameter setting process is performed, and the process then proceeds to step S27. The normal function parameter setting process will be described later. In step S27, it is determined whether or not the setting is completed. If the setting is completed, the process condition setting process ends, and if not completed, the process returns to step S21.

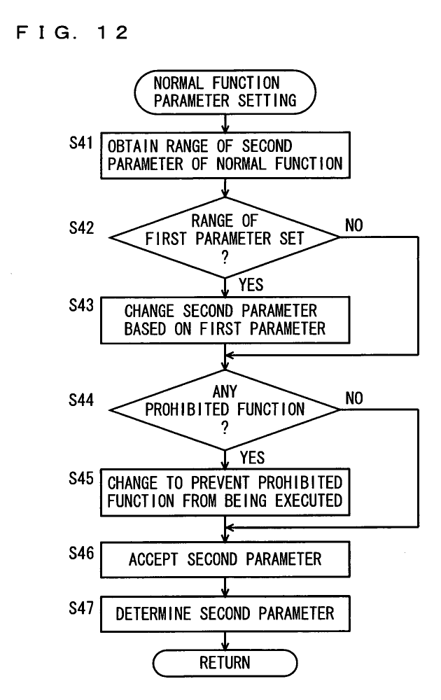

FIG. 11 is a flowchart illustrating an exemplary flow of the proxy function parameter setting process. The proxy function parameter setting process is a process performed in step S24 in FIG. 10. Referring to FIG. 11, a setting window is first obtained (step S31). The setting window is obtained which is identified by the URL associated with the apparatus ID accepted in step S23 in FIG. 10 and with the function ID for specifying a function as designated in step S21 in FIG. 10. The URL of the setting window related with a function ID may be received from other apparatuses, namely MFPs 100, 100B, 100C and PC 200 and then stored in HDD 113.

In the next step S32, the range of first parameters defined by the setting window received from proxy MFP 100 is obtained. Then, the ability information of the apparatus itself is obtained (step S33). Furthermore, based on the ability information, the range of first parameters obtained in step S32 is changed (step S34). Specifically, the range of first parameters is restricted so that the data on which a proxy function to be executed by proxy MFP 100 has been executed does not become data that cannot be executed with the ability of requestor MFP 100A. In addition, for the data that has been executed with the function within the ability of requestor MFP 100A, the range of first parameters is restricted so that the setting of a proxy function to be executed by proxy MFP 100 does not become excessive.

In step S35, it is determined whether or not a prohibited function which requestor MFP 100A is prohibited from executing is set. If a prohibited function is set, the process proceeds to step S36, and if not set, the process proceeds to step S37. In step S36, the range of first parameters is restricted so that the function prohibited from being executed is not executed in proxy MFP 100.

In step S37, the first parameter defined in the setting window obtained in step S31 is changed to the first parameter as changed in step S34 and step S36, and the process then proceeds to step S38. Then, the setting window is displayed on display portion 114 (step S38), and the first parameter is accepted (step S39). When the operator inputs the first parameter to operation portion 115, the first parameter is accepted from operation portion 115. Then, the first parameter to be transmitted to proxy MFP 100 is determined (step S40), and the process returns to the process condition setting process.

FIG. 12 is a flowchart illustrating an exemplary flow of the normal function parameter setting process. The normal function parameter setting process is a process performed in step S26 in FIG. 10. Referring to FIG. 12, in step S41, the range of the second parameters of the normal function is obtained. The range of second parameters which is stored beforehand corresponding to the function selected in step S21 in FIG. 10 is read from HDD 113. Then, it is determined whether or not the range of first parameters is set (step S42). If the range of first parameters is set, the process proceeds to step S43, and if not set, the process proceeds to step S46.

Then, based on the set range of first parameters, the range of second parameters obtained in step S41 is changed (step S43). Specifically, for the data that has been executed by proxy MFP 100 according to the first parameter, the range of second parameters is restricted so that the setting of the second parameter for execution by requestor MFP 100A does not become excessive. In addition, the range of second parameters is restricted so that data on which requestor MFP 100A has executed a function does not become data that cannot be executed by proxy MFP 100.

Then, it is determined whether or not a prohibited function which requestor MFP 100A is prohibited from executing is set (step S44). If a prohibited function is set, the process proceeds to step S45, and if not set, the process proceeds to step S46. In step S45, the range of second parameters is restricted so that the function prohibited from being executed is not executed in requestor MFP 100A.

Then, the second parameter is accepted (step S46), and the second parameter for executing the function selected in step S21 in FIG. 10 is determined (step S47). The process then returns to the process condition setting process.

As described above, when receiving a setting window for setting the first parameter for executing a function from proxy MFP 100, requestor MFP 100A in the second embodiment changes the range of first parameters defined by the setting window based on the ability information of the apparatus itself and accepts and transmits the first parameter to proxy MFP 100. Therefore, it can be avoided that data on which a proxy function has been executed by proxy MFP 100 becomes data that cannot be executed with the ability of requestor MFP 100A. In addition, for the data that has been executed by the function within the ability of requestor MFP 100A, the excessive setting of a proxy function to be executed by proxy MFP 100 is avoided.

Moreover, requestor MFP 100A changes the range of second parameters for executing a function to be executed by the apparatus itself, based on the range of first parameters determined to execute a proxy function in proxy MFP 100. Therefore, for the data that has been executed by proxy MFP 100 according to the first parameter, the excessive setting of a function to be executed by requestor MFP 100A is avoided. In addition, for the data on which requester MFP 100A has executed a function, a setting that prevents execution in proxy MFP 100 can be avoided.

Furthermore, when a prohibited function is set to restrict execution of a function in requestor MFP 100A, requestor MFP 100A restricts the range of first parameter so that the prohibited function is not executed. Therefore, it can be avoided that a process prohibited from being executed in requestor MFP 100A is executed in proxy MFP 100. In addition, when the security level is set high in requestor MFP 100A, a process that does not satisfy the security level is not allowed to be executed in proxy MFP 100.

In the foregoing embodiments, requestor MFP 100A and proxy MFP 100 have been described. However, any of MFPs 100, 100A, 100B, 100C and PC 200 may act as a requestor apparatus and any of them may act as a proxy apparatus. In particular, when PC 200 acts a proxy apparatus, an image processing function provided by PC 200 for image quality improvement and the like is executed.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An information processing apparatus comprising:
a request reception portion to receive a transmission request for a range of parameter necessary to execute a prescribed function from another information processing apparatus;
an information obtaining portion to receive prescribed information related to said another information processing apparatus;
a determination portion to determine a range of parameter that can be set to execute said prescribed function, based on said prescribed information received from said another information processing apparatus;
a transmission portion to transmit determined said range to said another information processing apparatus; and
an execution portion to execute said prescribed function according to a parameter received from said another information processing apparatus.

2. The information processing apparatus according to claim 1, wherein
said information obtaining portion includes an ability obtaining portion to obtain ability information of said another information processing apparatus, and
said determination portion determines a range of parameter that can be set to execute said prescribed function, based on obtained said ability information.

3. The information processing apparatus according to claim 1, wherein
said information obtaining portion includes a setting parameter obtaining portion to obtain a setting parameter set for a function executed in said another information processing apparatus, and
said determination portion determines a range of parameter that can be set to execute said prescribed function, based on obtained said setting parameter.

4. The information processing apparatus according to claim 1, wherein
said information obtaining portion includes a restriction obtaining portion to obtain restriction information that restricts execution of a process in said another information processing apparatus, and
said determination portion determines a range of parameter that can be set to execute said prescribed function, based on obtained said restriction information.

5. The information processing apparatus according to claim 1, further comprising a generation portion to generate a setting window in which a parameter that can be input is restricted within determined said range, wherein
said transmission portion transmits generated said setting window to said another information processing apparatus.

6. The information processing apparatus according to claim 5, wherein said setting window is described in a markup language.

7. The information processing apparatus according to claim 1, wherein determined said range includes at least one parameter option.

8. An information processing apparatus comprising:
a setting window obtaining portion to obtain from another information processing apparatus a setting window for setting a first parameter necessary for said another information processing apparatus to execute a prescribed function;
an alternative range determination portion to determine a range of said first parameter that can be set in said setting window, based on ability to execute a function of the apparatus itself;
a first parameter acceptance portion to accept said first parameter set in said setting window within said range determined for said first parameter; and
a request transmission portion to transmit accepted said first parameter to said another information processing apparatus for execution of said prescribed information.

9. The information processing apparatus according to claim 8, further comprising:
an execution portion to execute a previous function generating data on which said another information processing apparatus is allowed to execute said prescribed function or a subsequent function processing data on which said prescribed function has been executed by said another information processing apparatus;
an execution range determination portion to determine a range of second parameter for said execution portion to execute said previous function or said subsequent function, based on said range determined for said first parameter; and
a second parameter acceptance portion to accept set said second parameter within said range determined for said second parameter.

10. The information processing apparatus according to claim 8, wherein if a prohibited function which is prohibited from execution exists among functions held by the apparatus itself, said alternative range determination portion determines said range of said first parameter that can be set in said setting window so that said prohibited function is not executed.

11. The information processing apparatus according to claim 8, wherein said setting window is described in a markup language.

12. A proxy process execution method comprising the steps of:
receiving a transmission request for a range of parameter necessary to execute a prescribed function from another information processing apparatus;
receiving prescribed information related to said another information processing apparatus;
determining a range of parameter that can be set to execute said prescribed function, based on said prescribed information received from said another information processing apparatus;
transmitting determined said range to said another information processing apparatus; and
executing said prescribed function according to a parameter received from said another information processing apparatus.

13. A proxy process execution method comprising the steps of:
obtaining from another information processing apparatus a setting window for setting a first parameter necessary for said another information processing apparatus to execute a prescribed function;
determining a range of said first parameter that can be set in said setting window, based on ability to execute a function of an apparatus itself;
accepting said first parameter set in said setting window within said range determined for said first parameter; and
transmitting accepted said first parameter to said another information processing apparatus for execution of said prescribed function.

14. A proxy process execution program embodied on a computer readable medium for causing a computer to execute processing including the steps of:
receiving a transmission request for a range of parameter necessary to execute a prescribed function from another information processing apparatus;
receiving prescribed information related to said another information processing apparatus;
determining a range of parameter that can be set to execute said prescribed function, based on said prescribed information received from said another information processing apparatus;
transmitting determined said range to said another information processing apparatus; and
executing said prescribed function according to a parameter received from said another information processing apparatus.

15. A proxy process execution program embodied on a computer readable medium for causing a computer to execute processing including the steps of:
obtaining from another information processing apparatus a setting window for setting a first parameter necessary for said another information processing apparatus to execute a prescribed function;
determining a range of said first parameter that can be set in said setting window, based on ability to execute a function of an apparatus itself;
accepting said first parameter set in said setting window within said range determined for said first parameter; and
transmitting accepted said first parameter to said another information processing apparatus for execution of said prescribed function.
